(19) United States
(12) Patent Application Publication
(10) Pub. No.: US 2020/0160398 A1
(43) Pub. Date: May 21, 2020

(54) AUTOMATICALLY IDENTIFYING ADDITIONAL ENTITIES FOR CONTENT DELIVERY

(71) Applicant: Microsoft Technology Licensing, LLC, Redmond, WA (US)

(72) Inventors: Ruoyan Wang, Sunnyvale, CA (US); Liu Yang, Sunnyvale, CA (US); Dan Shacham, Sunnyvale, CA (US); Gaurav Chandalia, Fremont, CA (US)

(21) Appl. No.: 16/192,565

(22) Filed: Nov. 15, 2018

(51) Int. Cl. G06Q 30/02

(52) U.S. Cl. CPC G06Q 30/0269; G06Q 30/0246; G06Q 30/0277; G06Q 30/0275

(57) ABSTRACT

Technologies for associating an entity with a content delivery campaign are provided. Disclosed techniques include determining a first value of a profile attribute of the entity. A particular node that matches the first value is identified from a value tree of nodes. A parent node of the particular node is identified from the value tree. Child nodes of the parent node are identified, where the child nodes do not include the particular node. Values from the child nodes are then associated with the profile attribute of the entity. A particular value is received for a particular targeting criterion of the content delivery campaign. It is determined whether the particular value matches a value of the child nodes, where the particular value does not match the first value. In response to determining that the particular value matches a value of the child nodes, associating the entity with the content delivery campaign.

### TECHNICAL FIELD

The present disclosure relates to identifying additional users for content delivery by analyzing attributes of users, and more specifically, to computer software that analyzes user attribute values and determines similar attribute values that may be associated with users for the purpose of identifying additional users based upon targeting criteria matching similar attribute values associated with users.

### BACKGROUND

Content delivery systems are configured to deliver relevant content to users by determining a set of users that may be interested in the content to be delivered. The content delivery systems may target their content to users that have shown interest in the content or subject matter related to the content. For example, if the content delivery system intends to deliver content related to truck driving job opportunities, then the content delivery system may target a set of users that are currently truck drivers. However, identifying a set of users that have the same profession as the profession explicitly associated with the content may limit the set of users to a small set of users.

Content delivery systems may expand their audience of relevant users by using lookalike targeting. Lookalike targeting is a technique for finding additional users that have characteristics similar to those users originally targeted. For example, if the original targeting campaign targeted users that are currently truck drivers, then lookalike targeting may find additional users based on attributes of users, such as whether users are from the same company, have the same academic degree, and/or the same skills. However, lookalike campaigns often rely on the description accuracy of the user attributes and characteristics. If users define their current profession using non-standard terms, then the content delivery system may erroneously target users not interested in the content items. For instance, if users define their profession using terms like “Technology driver” or “Service delivery engineer” the content delivery system may add such users to the set of users eligible for receiving content related to truck driving opportunities even though the additional users are not truck drivers or even drivers at all. As a result, conventional content delivery systems are not effective in determining additional users that may be targeted for a content delivery.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment.

FIG. 2 depicts a block diagram of an example software-based system for identifying additional attribute values that are related to an attribute value currently assigned to an entity, in an embodiment.

FIG. 3 depicts an example portion of a job title value tree of nodes, in an embodiment.

FIG. 4 depicts an example flowchart for associating one or more additional attribute values to an attribute value assigned to an entity and associating the entity to a content delivery campaign based upon matching targeting criterion, in an embodiment.

FIG. 5 depicts an example flowchart for identifying additional targeting criteria for a content delivery campaign, in an embodiment.

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

As disclosed herein, identifying additional users for a content delivery campaign is improved by adding technology that implements a particular approach of classifying different user attributes in a data structure such that similar attribute values may be discovered based upon their relationship to the attribute value targeted by a content delivery campaign. One particular approach may determine a first value of a particular profile attribute of an entity. The approach may implement a hierarchy tree as the data structure for modelling relationships between attribute values of a particular attribute of entities. The disclosed approach may identify, within the hierarchy tree, a particular node that matches the first value of the particular profile. A parent node of the particular node may be identified and then one or more child nodes of the parent node may be identified. The one or more child nodes may represent nodes that are related to the particular node based upon their common parent node. Values from the one or more child nodes may then be associated with the particular profile.

The disclosed approaches may implement a content delivery campaign to determine a target set of users. The target set of users may be expanded by identifying users that have attribute values that are similar to the targeting criterion. The disclosed approaches may receive a particular targeting criterion for the content delivery campaign. One approach may determine whether an entity matches the value of the particular targeting criterion by determining whether the particular targeting criterion value matches a value of the one or more child nodes associated with an entity. If the targeting criterion matches a value of the one or more child nodes of an entity, then the entity may be associated with the content delivery campaign for the purpose of delivering relevant content to entities.

The disclosed approaches provide advantages over conventional solutions by eliminating targeted users that may have been identified based upon similarities that have been erroneously identified using conventional solutions. The disclosed approaches identify similar attribute values within the hierarchical data structure that accurately maps relationships between the various attributes. The hierarchical data structure provides increased accuracy in determining similarities between attributes values which in turn may be used to identify additional relevant users for the content delivery campaign, which may reduce processing resources consumed by evaluating and delivering content items to users that may not be relevant to the content delivery campaign.

### System Overview

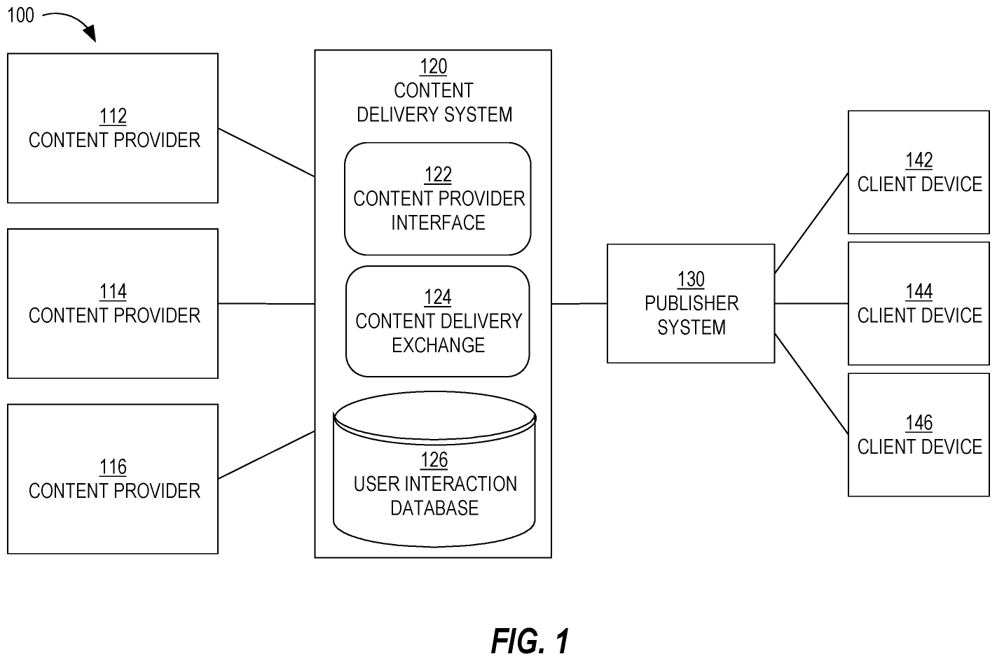

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item summaries, across client devices 152-156 (and other client devices not depicted). For example, content delivery system 120 determines whether a content item summary that content delivery exchange 124 delivers is presented at (e.g., displayed by or played back at) a client device. Such an “event” is referred to as an “impression.” As another example, content delivery system 120 determines whether a content item summary that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 128. Logging such events allows content delivery system 120 to track how well different content items and/or campaigns perform.

For example, content delivery system 120 receives impression data items, each of which is associated with a different instance of an impression and a particular content item summary. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item summary, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item summary, content delivery system 120 may calculate a CTR for the content item summary.

### Attribute Expansion System

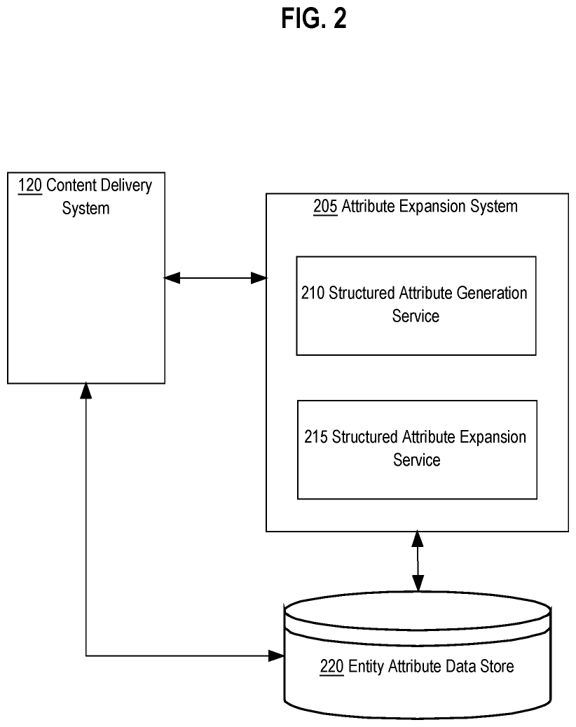

FIG. 2 depicts a block diagram of an example software-based system for identifying additional attribute values that are related to an attribute value currently assigned to an entity. An entity may refer to a user or a user's profile. For the purposes of this disclosure the terms entity, user, and user profile may be used interchangeably. In an embodiment, the attribute expansion system 205 may be configured to use one or more hierarchical data structures to identify other attribute values that are related to attribute values assigned to the entities. The one or more hierarchical data structures may represent hierarchical relationships between attribute values of entities. For example, the attribute expansion system 205 may use a hierarchical data structure that contains nodes of job titles to identify similar job titles related to a particular job title that is assigned to an entity. The additional job titles may then be targeted by a content delivery campaign in order to identify additional entities for content item delivery.

In an embodiment, the content delivery system 120 may utilize attribute expansion for the purpose of finding additional users that may have an attribute value similar to a targeted attribute of a content delivery campaign. For example, a content delivery campaign may specify a target value of “Frontend engineer” for a job title attribute. The content delivery system 120 may utilize the one or more hierarchical data structures to select other attribute values that are similar to the targeted attribute by providing the target attribute value that matches an attribute value stored in the one or more hierarchical data structures. The selected other attribute values may then be used to find additional users with a job title that is similar to “Frontend engineer.”

In an embodiment, the attribute expansion system 205 may be communicatively coupled to the content delivery system 120 for the purposes of determining entities that match targeting criteria of a content delivery campaign. In another embodiment (not shown in FIG. 2), the attribute expansion system 205 may be integrated as part of the content delivery campaign 120.

In an embodiment, the attribute expansion system 205 may include a structured attribute generation service 210 and a structured attribute expansion service 215. The structured attribute generation service 210 may be configured to generate one or more hierarchical data structures based on one or more attributes associated with entities. As described, entities may represent user profiles and associated attributes of entities may represent different user characteristics associated with the user profiles. For example, associated attributes may include job title, skills, user geo-location, and many others.

The structured attribute expansion service 215 may be configured to identify one or more attribute values from a hierarchical data structure that is related to a particular attribute value assigned to a particular user profile. For example, if the particular attribute is a job title and the particular attribute value from the user profile is “database engineer” then the structured attribute expansion service 215 may identify additional job titles from the hierarchical data structure that are closely related to the database engineer job title. In an embodiment, an entity attribute data store 220 may represent data storage configured to store entities, such as user profiles, and attribute values for a plurality of entity. For example, the entity attribute data store 220 may store user profiles for users, including the associated user profile attribute values.

### Structured Attribute Data Structure

A structured attribute data structure may be a hierarchical data structure containing attributed values and relationships between the attribute values. In an embodiment, the hierarchical data structure may be a value tree containing a root node and levels of additional nodes that form a hierarchy. In one example, the attribute values may represent different job titles of users derived from attributes from user profiles. The root node is the top level node and may represent a broadest job title that includes all other derived job titles. Child nodes that descend directly from the root node may each represent a distinct job title that is a subset of the root node. Subsequent child nodes may each represent a distinct subset of their parent node. For example, if a parent node represents the job title of “Engineer” then child nodes of the parent may include “Software Engineer,” “Hardware Engineer,” “Support Engineer,” “QA Engineer,” and so on. In other examples, attributes values from the value tree may include, but are not limited to, skills, geo-location of users, occupational industry, education, and many others.

In an embodiment, nodes in the value tree may represent a specific structured attribute that is derived from one or more attributes from user profiles. In some cases, semantic properties of attribute values may be analyzed to identify specific properties that make up a structured attribute. For example, if the structured attribute represents a structured job title, then various properties may be identified from one or more profile attribute values. Attributes for the structured job title may include, but are not limited to, role, specialty, seniority, accreditation, and employment status.

In an embodiment, the structured attribute generation service 210 may implement natural language processing tools, which may include machine learning, to identify various structured attributes from existing properties associated with user profiles. For instance, the role attribute may represent what the user does in his current profession. This may be identified from a user's current job listed in their profile. The specialty attribute may represent information about an explicit skill or domain not explicitly expressed in the role attribute. For example, user profile may indicate that the user is a “java software engineer.” This title may be analyzed to identify a role of software engineer and a skill of “java.” The seniority attribute may represent a level of responsibility associated with the user profile. For instance, seniority may be identified from the title of “senior software engineer.” The accreditation attribute may represent a type of accreditation associated with the job title, such as registered, certified, or PhD. The employment status attribute may represent the current employment relation between the position and the company, such as full-time, part-part, or independent contractor.

In an embodiment, the structured attribute generation service 210 may generate a value tree of nodes using structured attributes derived from characteristics assigned to a plurality of user profiles. For example, the structured attribute generation service 210 may generate structured job title nodes using one or more structured attributes such as the role and specialty attributes. Parent-child node relationships may be based upon the determined structured job titles where the role attribute between a parent and a child node is the same. The specialty attribute, which represents user skills, may be used to further define the hierarchy tree. Parent nodes may be configured to have broader specialties that include the specialties of the child nodes, while the child node specialty represents a more specific specialty that is a subset of the specialty of the parent node.

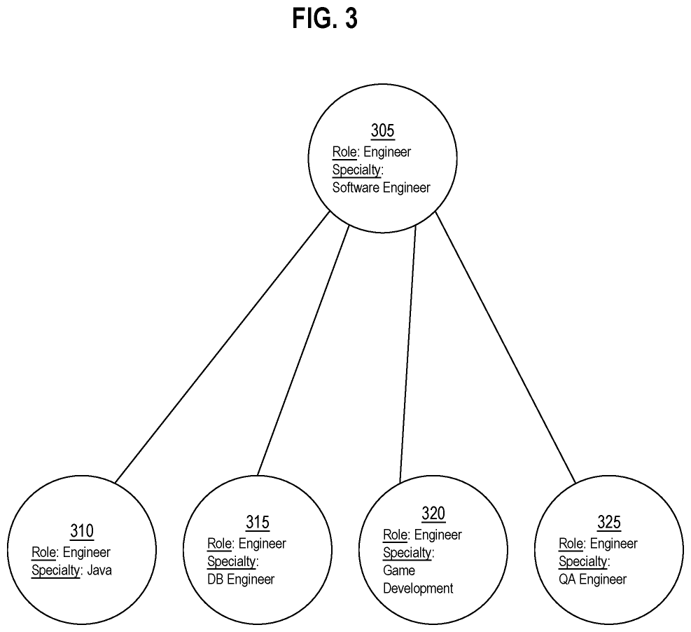

FIG. 3 depicts an example portion of a job title value tree. In an embodiment, node 305 represents a particular parent node within the job title value tree. The role assigned to node 305 is “engineer” and the specialty assigned is “software engineer.” Child node 310 is a child of node 305. Child node 310 has a role of “engineer” and a specialty of “Java.” Child node 315 is a node of node 305 and has a role of “engineer” and a specialty of “DB (database) engineer.” Child node 320 is a child of node 305 and has a role of “engineer” and a specialty of “game development.” Child node 325 is a child of node 305 and has a role of “engineer” and a specialty of “QA engineer.” All of the child nodes of node 305 have the same role as node 305. Each of the specialties of child nodes 310-325 are sub-specialties of the specialty “software engineer” (assigned to node 305). Other embodiments of the job title value tree are not limited to using the role and specialty for structuring the hierarchy between nodes. Other attributes may be used along with role and specialty or in place of role and specialty to structure the hierarchy between nodes.

In an embodiment, the structured attribute generation service 210 may populate the value tree with nodes by analyzing entities from the entity attribute data store 220. The structured attribute generation service 210 may derive specific attributes used for defining relationships within the value tree using dictionary-based text analysis. These specific attributes may be referred to as core attributes. Using the current example, the structured attribute generation service 210 may use dictionary-based text analysis to identify the role and specialty core attributes. The structured attribute generation service 210 may then extract and identify additional attributes such as seniority, employment status, and accreditation. These additional attributes may be used to further define relationships between nodes in the hierarchy tree. For example, if a user's job title property within his profile is “Certified Java Engineer—Intern” and his profile has a property value indicating that he is a part-time employee, then the structured attribute generation service 210 may extract and identify “engineer” as the user's role, “Java” as the user's specialty, “Certified Java” as an accreditation for the user, “Intern” as the user's seniority, and “part-time” as the user's employment status.

In an embodiment, the structured attribute generation service 210 may assign a structured attribute value to the corresponding entity. For example, as the structured attribute generation service 210 generates nodes for each of the structured attribute values determined from the user profiles, the structured attribute generation service 210 may assign each structured attribute value to their corresponding user profile. As a result, each user profile may have an assigned structured attribute value which may be used to look up the corresponding node within the value tree. In an embodiment, the assigned structured attribute value may be publicly hidden from view on the user's profile. For example, if the structured attribute is a structured job title and the structured attribute value is “Engineer—Java,” then the structured attribute value may be hidden from public view of the user profile but may be used for search purposes, such as for determining matching user profiles for a content delivery campaign.

In an embodiment, the structured attribute generation service 210 may, when generating nodes, analyze user profiles to compile metrics describing the number of user profiles associated with each of the nodes in the value tree. The structured attribute generation service 210 may generate metrics for a particular node that describes the number of user profiles that have been assigned the structured attribute value associated with the particular node. For example, if, after analyzing user profiles in the entity attribute data store 220, the structured attribute generation service 210 determines that 1200 users are associated with node 310 (role—engineer, specialty—java), then the structured attribute generation service 210 may generate a node property value that stores the number of users currently associated with node 310. Associated metrics may then be used to determine sets of relations between different groups of users based on their respective structured attribute values. In other embodiments, which include other hierarchy trees based on different attribute values, the structured attribute generation service 210 may aggregate data related to users in order to generate relevant metrics for the corresponding nodes of the other hierarchy trees.

### Structure Attribute Expansion

In an embodiment, the structured attribute expansion service 215 may identify one or more additional structured attribute values that are closely related to an assigned structured attribute value of a particular entity. The structured attribute expansion service 215 may associate the one or more additional structured attribute values to the particular entity, such that the particular entity may be associated with a content delivery campaign when the targeting criterion of the content delivery campaign matches one of the one or more additional structured attributes.

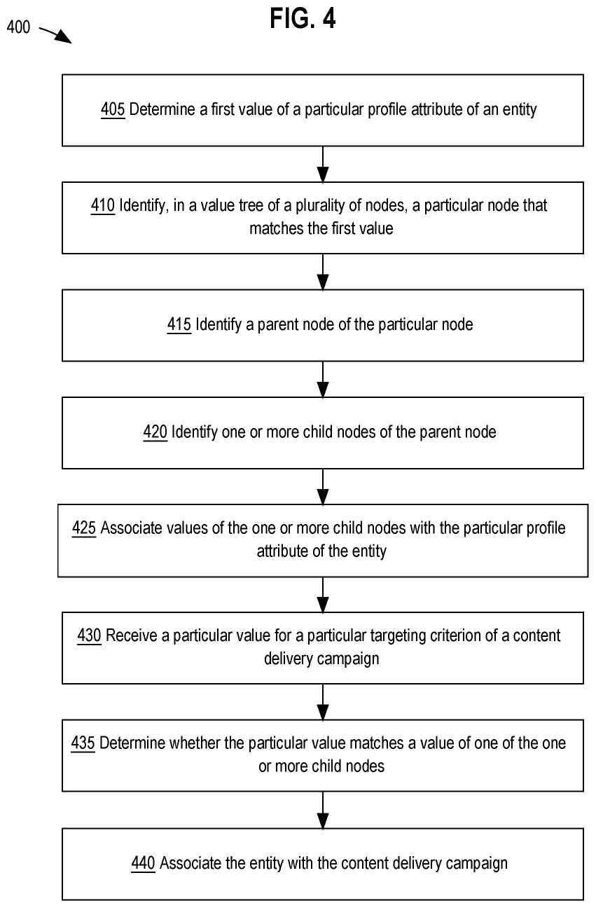

FIG. 4 depicts an example flowchart for associating one or more additional attribute values to an attribute value assigned to an entity and associating the entity to a content delivery campaign based upon matching targeting criterion to the one or more additional attribute values. Process 400 may be performed by a single program or multiple programs. The operations of the process as shown in FIG. 4 may be implemented using processor-executable instructions that are stored in computer memory. For purposes of providing a clear example, the operations of FIG. 4 are described as performed by the structured attribute expansion service 215 implemented on the attribute expansion system 205 and the content delivery system 120. For the purposes of clarity process 400 is described in terms of a single entity. In an embodiment, the structured attribute expansion service 215 may perform the operations of process 400 on a set of entities or each of the entities in the entity attribute data store 220. The structured attribute expansion service 215 may be configured to periodically perform the operations of process 400 on entities, for instance on a daily basis, or on-demand when requested by the content delivery system 120.

In operation 405, process 400 determines a first value of a particular profile attribute of an entity. In an embodiment, the structured attribute expansion service 215 may, as part of a scheduled service or on-demand, identify an entity, such as a user profile, and may identify the structured attribute value as the first value of a particular profile attribute from the user profile. For example, the structured attribute expansion service 215 may identify a structured job title assigned to the user profile and may determine that the value of the structured job title is “database engineer.” As described previously, a structured attribute value associated with the user profile may be a standardized or formatted value. By preformatting structured attribute values, the values associated with user profiles may avoid misidentification related to spelling errors or non-standard descriptions. In an embodiment, the structured attribute value may be hidden from public view. For example, users who view a particular user profile may be unable to view and edit the structured attribute values as the values are used for identification purposes by the structured attribute expansion service 215.

In operation 410, process 400 identifies, in a value tree of a plurality of nodes, a particular node that matches the first value. In an embodiment, the structured attribute expansion service 215 may identify the value tree that corresponds to the structured attribute type of the first value determined in operation 405. Using the previous example, the structured attribute expansion service 215 may identify the particular value tree that corresponds to structured job titles. Upon identifying the particular value tree, the structured attribute expansion service 215 may identify a particular node that matches the first value. For example, referring to FIG. 3 the structured attribute expansion service 215 may identify node 315 as matching the first value, where the first value is “database engineer.”

In operation 415, process 400 identifies a parent node for the particular node identified in operation 410. In an embodiment, the structured attribute expansion service 215 may identify the parent node of the particular node by moving up one level of the value tree. Referring to FIG. 3, the particular node identified in operation 410 is node 315. The structured attribute expansion service 215 may then move up one level from node 315 to node 305, which is the parent node of node 315. As described previously for the structured job title value tree, the core components of role and specialty are used in defining nodes in the value tree and relationships between the nodes. A parent node and its corresponding child nodes have the same role. For example, node 315 (child node) and node 305 (parent node) both have a role of engineer.

In an embodiment, the parent node of the structured job title value tree, with respect to the specialty core component, has a broader specialty that encapsulates the specialties of its corresponding child nodes. For instance, node 305 (parent node) has a specialty of software engineer and node 315 (child node) has a specialty of database engineer, where software engineer specifies a broader specialty that also encapsulates the specialty of database engineer. In other embodiments, the parent-child node relationship may be based on one or more other structured attributes, where the structured attribute values of the parent node are broader and encapsulate the structured attribute values of the child node.

In another embodiments, where the hierarchical data structure is represented using a data structure other than a tree, the structured attribute expansion service 215 may still identify a parent node using node property values that indicate node hierarchies. For example, if the hierarchical data structure is a series of lists, then the structured attribute expansion service 215 may identify the specific list corresponding to the particular node and its parent node.

In operation 420, process 400 identifies one or more child nodes of the parent node, other than the particular node identified in operation 410. In an embodiment, the structured attribute expansion service 215 may identify one or more child nodes of the parent node. The one or more child nodes identified do not include the particular node and are therefore sibling nodes of the particular node. For example, the structured attribute expansion service 215 may identify nodes 310, 320, and 325, which are child nodes of node 305 (parent node).

In an embodiment, the one or more child nodes identified by the structured attribute expansion service 215 may be a subset of the total number of child nodes of the parent node. The structured attribute expansion service 215 may be configured to select only a subset of the child nodes that may have a meaningful relationship to the particular node, for the purposes of identifying additional entities related to target criterion. In an embodiment, the subset of the total number of child nodes may include child nodes that have at least a minimum number of associated entities. For instance, the minimum number of entities associated with a child node may be set to 300. That is, in order to satisfy the minimum number threshold, structured job titles of child nodes must be assigned to at least 300 entities in the entity attribute data store 220. If there are over 300 entities that have been assigned node 310 (Java—engineer), then node 310 would satisfy the minimum number threshold requirement. If, however, only 50 entities have been assigned node 320 (Game development—engineer), then node 320 would not satisfy the minimum number threshold requirement and the structured attribute expansion service 215 would not include node 320 as part of the one or more child nodes identified in operation 420.

In other examples, the one or more child nodes identified in operation 420 may implement other child node requirements such as a maximum threshold value or determining whether child nodes have other attributes that match attributes of the particular node. For example, if the particular node identified in operation 410 further specifies a seniority value of intern, then the structured attribute expansion service 215 may only identify child nodes of the parent node that also have a seniority value of intern. By selecting subsets of child nodes that satisfy either a min/max threshold or match other attributes from the particular node, the structured attribute expansion service 215 may ensure that only closely related nodes are selected.

Referring back top FIG. 4, in operation 425, process 400 associates the values of the one or more child nodes with the particular profile attribute of the entity. The values of the one or more child nodes may be referred to as additional structured attributes. For example, the structured attribute expansion service 215 may associate the structured job title values from the one or more child nodes to the particular profile attribute, which is the assigned structured job title, of the entity. By doing so, the structured attribute expansion service 215 associates the closely related structured job titles, the additional structured attributes, to the existing job title of the entity. The additional structured attributes may be searched against when determining a pool of matching entities for a content delivery campaign.

### Expanding Targeted Audience of Content Delivery Campaign

A content delivery campaign may include targeting criteria that may be used to determine whether to present a content item of the content delivery campaign to specific users. The targeting criteria may be compared to assigned structured attribute values of user profiles to determine whether a user should be presented with a content item of the content delivery campaign. For example, if the targeting criteria specifies a structured job title of “database engineer”, then the content delivery system 120 may search for matching users that have a structured job title of “database engineer.” However, determining a set of users based upon only matching the structured job title value limits the pool of users to users that have a structured job title of “database engineer.”

In an embodiment, the content delivery system 120 may be configured to compare the targeting criteria to similar structured attribute values from one or more sibling child nodes that have been associated to an entity by the structured attribute expansion service 215. Using the structured job title as an example, the content delivery system 120 may compare the targeting criteria that specifies a structured job title value to the structured job title assigned to user profiles as well as additional structured job titles from sibling child nodes that have been associated with the user profiles. By doing so, the audience of users targeted by the content delivery campaign may be expanded to include users that have a structured job title that is similar to the structured job title specified in the content delivery campaign.

Referring back to FIG. 4, in operation 430 process 400 receives a particular value for a particular targeting criterion of a content delivery campaign. In an embodiment, the content delivery system 120 may receive targeting criterion for a content delivery campaign. For example, the targeting criterion received may specify a structured job title value of “QA engineer.” In an embodiment, the targeted criterion may represent a specific structured job title stored within the structured job title value tree. For example, when creating the content delivery campaign, the content delivery system 120 may present a user with a list of structured job titles from the structured job title value tree. The user may select targeting criterion from the list of structured job titles. The content delivery system 120 may then use the selected targeting criterion to search for additional nodes that represent job titles that are similar to the targeting criterion. In another embodiment, the user may provide keywords that represent targeting criterion to the content delivery system 120. The content delivery system 120 may then search for a node, within the structured job title value tree, that represents the closest job title to the keywords provided by the user.

The content delivery system 120 may determine an initial set of targeted users by comparing the targeting criterion for a structured job title to the structured job title attribute assigned to users. The content delivery system 120 may then expand the set of targeted users by then comparing the targeting criterion to additional structured job title attributes associated with other users.

In operation 435, process 400 determines whether the particular value matches a value of the one or more child nodes associated with the particular profile attribute of the entity. In an embodiment, the content delivery system 120 may compare the value of the targeting criterion to values of the additional structured attributes, which represent similar attribute values that have been associated with the particular profile attribute of the user. Using the structured job title as an example, the content delivery system 120 may compare the structured job title value of “QA engineer” to the additional structured job titles associated with users that have an assigned structured job title other than “QA engineer.” For instance, during operation 425, users that have a structured job title of “Java—engineer,” “database—engineer,” and “game development—engineer” (specified by nodes 310, 315, and 320 respectively) may have had the similar structured job title of “QA engineer” associated to their user profile. The content delivery system 120 may use these similar structured job titles to identify additional users that may have an interest in the content delivery campaign based upon their sibling relationship to the targeting criterion.

In operation 440, process 400 associates the entity with the content delivery campaign. In an embodiment, the content delivery system 120 may expand the set of targeted users by associating the user identified as having an additional structured job title that matches the targeting criterion. For example, if a user that has an assigned structured job title of “database engineer” and also has associated additional structured job titles that includes QA engineer, then the user may have an interest in the content items of the content delivery campaign based upon the sibling relationship between the user's assigned structured job title and the structured job title specified in the targeting criterion.

Upon associating additional users to the content delivery campaign, the content delivery system 120 may be configured to generate performance metrics for the content delivery campaign related to the set of targeted users, which includes additional users added to the set of targeted users based upon sibling relationships of attribute values. In an embodiment, the content delivery system 120 may differentiate targeted users based upon how each user was identified. For instance, the content delivery system 120 may identify different sets of targeted users based upon their relationship to the targeting criterion. For example, if the targeting criterion specified a structured job title of “QA engineer,” then one set of targeted users may include a set of users that have an assigned structured job title equal to “QA engineer.” Another set of targeted users may be identified as a set of users that have an assigned structured job title equal to a sibling job title, such as “Java—engineer” where these users have an associated set of additional structured job titles that include “QA engineer.” Table A below illustrates example sets of targeted users that may be tracked by the content delivery system 120. The values presented in table A are values used to illustrate the features of tracking performance metrics of different sets of targeted users. The values may not necessarily represent measured values from the content delivery campaign 120.

TABLE A

| | QA | Java | Game | DB |
|---|---|---|---|---|
| Target criterion: | Engineer | Engineer | Developer | Engineer |
| QA Engineer | User set | User set | User set | User set |
| Click through | 2.5% | 2% | 0.1% | 10% |
| rate | | | | |
| Conversion rate | 1.5% | .5% | 0.01% | 5% |

In an embodiment, the content delivery campaign 120 may track performance metrics such as click through rates, conversion rates, and others for each type of user associated with the content delivery campaign. For users associated to the content delivery campaign based upon a sibling structured job title relationship, the performance metrics may be associated with the corresponding sibling nodes in order to define a closeness between a particular node and its sibling node. For example, if the targeted criterion specified “QA engineer” as the targeted structured job title, which corresponds to node 325 in the structured job title hierarchy tree, then performance metrics for click through rates and conversion rates for the set of users associated with the sibling structured job title of “Java—engineer” may be associated with node 310. Similarly, performance metrics for the other sibling structured job titles may be associated with the remaining sibling nodes 315 and 320 respectively.

In an embodiment, the associated performance metrics may be used by the structured attribute expansion service 215 when selecting one or more sibling nodes to associate to entities during future operations of process 400. For example, the performance metrics may be used to sort sibling nodes based upon click through rate or conversion rate and identify which sibling nodes perform well for content delivery campaigns and which sibling nodes perform poorly. For example, referring to table A where the identified structured job title is “QA engineer,” the performance metrics indicate that structured job titles “Java engineer” and “Database engineer” (node 310 and node 315) perform well when associated with the structured job title “QA engineer” based upon the click through and conversion rates. However, structured job title “Game development” (node 320) performs poorly as the performance metrics indicates that the click through and conversion rates are a fraction of the click through and conversion rates of the matching structured job title “QA engineer”. As a result, during future operations of process 400 the structured attribute expansion service 215 may only associate values of “Java engineer” and “Database engineer” (node 310 and node 315) to entities that have a structured job title of “QA engineer.”

As described previously, the operations of process 400 are not limited to the structured job title attribute. The operations may be performed on other profile attributes using hierarchy trees for the other attribute values.

### Expanding Targeting Criteria of Content Delivery Campaign

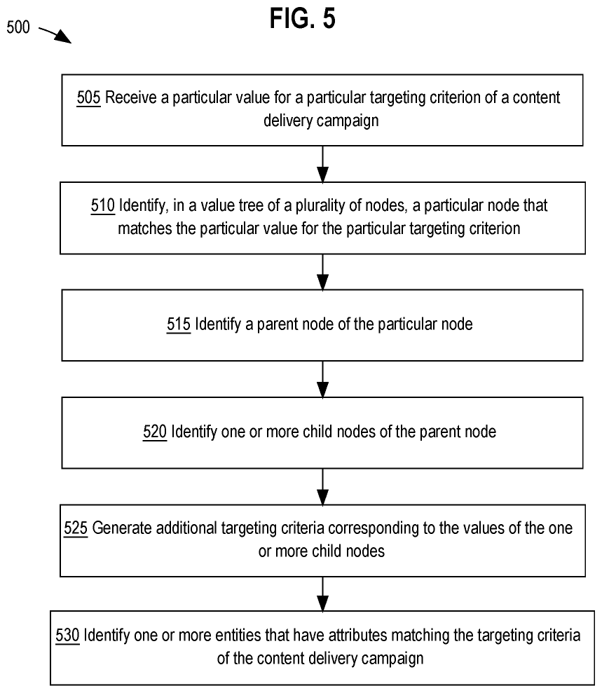

In an embodiment, the content delivery system 120 may use the one or more hierarchical data structures to discover additional targeting criteria for the content delivery campaign. FIG. 5 depicts an example flowchart for identifying additional targeting criteria for a content delivery campaign. Process 500 may be performed by a single program or multiple programs. The operations of the process as shown in FIG. 5 may be implemented using processor-executable instructions that are stored in computer memory. For purposes of providing a clear example, the operations of FIG. 5 are described as performed by the content delivery system 120 and the structured attribute expansion service 215. For the purposes of clarity process 500 is described in terms of a single entity.

In operation 505, process 500 receives a particular value for a particular targeting criterion of a content delivery campaign. In an embodiment, the content delivery system 120 may receive targeting criterion for a content delivery campaign. For example, the targeting criterion received may specify a structured job title value of “Java—engineer.”

In operation 510, process 500 identifies, in a value tree of a plurality of nodes, a particular node that matches the particular value of the content delivery campaign. In an embodiment, the content delivery system 120 may communicate with the structured attribute expansion service 215 to identify the value tree that corresponds to the structured attribute type of the particular value received in operation 505. For example, the structured attribute expansion service 215 may determine that the particular value of “Java—engineer” corresponds to a structured job title attribute type. The structured attribute expansion service 215 may then identify the value tree corresponding to structured job titles and then identify within the structured job title value tree, the particular node corresponding to the particular value of the content delivery campaign.

In operation 515, process 500 identifies a parent node for the particular node identified in operation 510. In an embodiment, the structured attribute expansion service 215 may identify the parent node of the particular node by moving up one level of the value tree. Referring to FIG. 3, the particular node identified in operation 510 is node 310 (Java—engineer). The structured attribute expansion service 215 may then move up one level from node 310 to node 305, which is the parent node of node 310.

In operation 520, process 500 identifies one or more child nodes of the parent node, other than the particular node identified in operation 510. In an embodiment, the structured attribute expansion service 215 may identify one or more child nodes of the parent node. The one or more child nodes identified do not include the particular node and are therefore sibling nodes of the particular node. For example, the structured attribute expansion service 215 may identify nodes 315, 320, and 325, which are child nodes of node 305 (parent node).

In operation 525, process 500 generates additional targeting criteria corresponding to the values of the one or more child nodes for the content delivery campaign. In an embodiment, the structured attribute expansion server 215 may send the values of the one or more child nodes to the content delivery system 120. The content delivery system 120 may then use the values of the one or more child nodes to generate additional targeting criteria for the content delivery campaign. For example, the structured attribute expansion server 215 may send values of nodes 315, 320, and 325, which correspond to “database engineer,” “game development engineer,” and “QA engineer.” The content delivery system 120 may receive the values and may generate targeting criteria that includes the terms of “database engineer,” “game development engineer,” and “QA engineer.”

In operation 530, process 500 may identify one or more entities that have attributes matching the targeting criteria of the content delivery campaign. In an embodiment, the content delivery system 120 may search for entities in the entity attribute data store 220 that have attributes that match the targeting criteria. For instance, the content delivery campaign 120 may search for entities that have job title attributes that match the targeting criteria that includes “java engineer,” “database engineer,” “game development engineer,” and “QA engineer.”

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

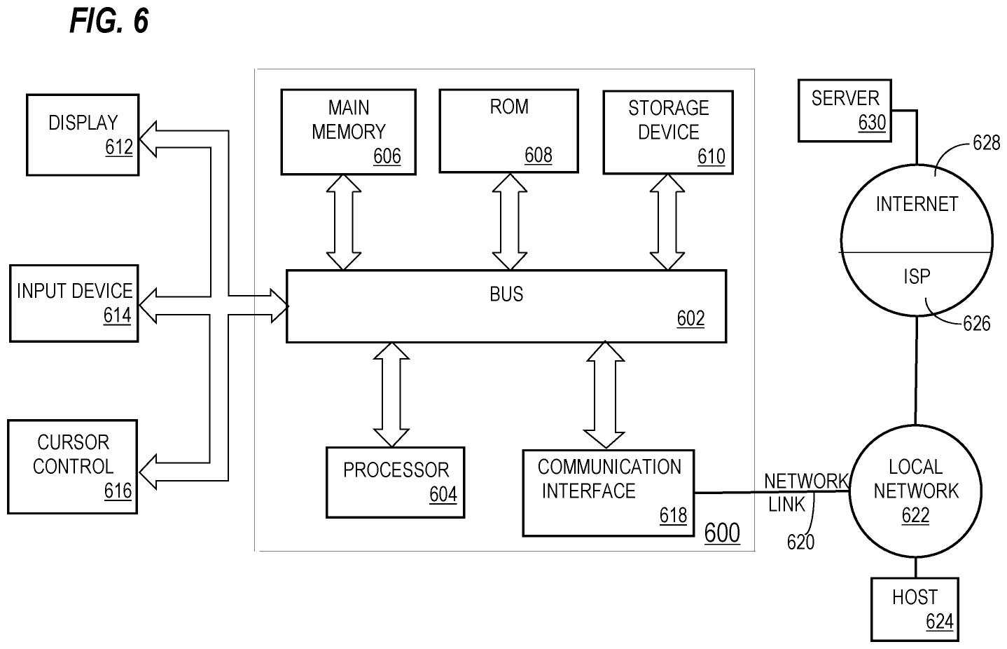

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for associating an entity with a content delivery campaign, the method comprising:
determining a first value of a particular profile attribute of the entity;
identifying, in a value tree of a plurality of nodes, a particular node that matches the first value;
identifying, in the value tree, a parent node of the particular node;
identifying, in the value tree, one or more child nodes of the parent node, wherein the one or more child nodes do not include the particular node;
associating values of the one or more child nodes with the particular profile attribute of the entity;
receiving a particular value for a particular targeting criterion of the content delivery campaign;
determining whether the particular value matches a value of one of the one or more child nodes, wherein the particular value does not match the first value; and
in response to determining that the particular value matches a value of one of the one or more child nodes, associating the entity with the content delivery campaign;
wherein the method is performed by one or more computing devices.

2. The method of claim 1, wherein identifying the one or more child nodes comprises:
identifying a plurality of child nodes of the parent node, wherein the plurality of child nodes does not include the particular node; and
identifying the one or more child nodes of the plurality of child nodes having an attribute value greater than or equal to a particular attribute threshold that defines desirable attribute values for association with the particular profile attribute of the entity, wherein the one or more child nodes are at least a subset of the plurality of child nodes.

3. The method of claim 2, wherein the attribute value of a particular child node represents a number of entities having a profile attribute value matching the particular child node.

4. The method of claim 1, wherein each node of the plurality of nodes of the value tree represents a unique structured job title, and wherein each unique structured job title comprises a role that defines duties of the entity, and a specialty that defines a specific skill of the entity.

5. The method of claim 4, wherein the parent node has an associated role that is equal to a role of the particular node.

6. The method of claim 4, wherein the parent node has an associated specialty that is broader than a specialty of the particular node.

7. The method of claim 1, further comprising:
wherein associating the entity with the content delivery campaign comprises associating the entity and a value of the matched child node to the content delivery campaign;
identifying sets of entities associated with the content delivery campaign, wherein each set of the sets of entities represent a match based upon a value corresponding to a specific job title; and
determining performance metrics of each of the sets of entities associated with the content delivery campaign, wherein the performance metrics are based upon click-through rate of entities.

8. The method of claim 7, further comprising:
associating the performance metrics of each of the sets of entities to a click-through performance attribute value of the corresponding one or more child nodes; and wherein the click-through performance attribute value of the corresponding one or more child nodes is used to identify child nodes for future associations to the particular profile attribute of the entity for future content delivery campaigns.

9. The method of claim 1, wherein the particular profile attribute is job title or skills.

10. A system for associating an entity with a content delivery campaign, the system comprising:
one or more computer processors;
a content delivery system coupled to the one or more processors, wherein the content delivery system performs operations comprising:
determining a first value of a particular profile attribute of the entity;
identifying, in a value tree of a plurality of nodes, a particular node that matches the first value;
identifying, in the value tree, a parent node of the particular node;
identifying, in the value tree, one or more child nodes of the parent node, wherein the one or more child nodes do not include the particular node;
associating values of the one or more child nodes with the particular profile attribute of the entity;
receiving a particular value for a particular targeting criterion of the content delivery campaign;
determining whether the particular value matches a value of one of the one or more child nodes, wherein the particular value does not match the first value; and
in response to determining that the particular value matches a value of one of the one or more child nodes, associating the entity with the content delivery campaign.

11. The system of claim 10, wherein identifying the one or more child nodes comprises:
identifying a plurality of child nodes of the parent node, wherein the plurality of child nodes does not include the particular node; and
identifying the one or more child nodes of the plurality of child nodes having an attribute value greater than or equal to a particular attribute threshold that defines desirable attribute values for association with the particular profile attribute of the entity, wherein the one or more child nodes are at least a subset of the plurality of child nodes.

12. The system of claim 11, wherein the attribute value of a particular child node represents a number of entities having a profile attribute value matching the particular child node.

13. The system of claim 10, wherein each node of the plurality of nodes of the value tree represents a unique structured job title, and wherein each unique structured job title comprises a role that defines duties of the entity, and a specialty that defines a specific skill of the entity.

14. The system of claim 13, wherein the parent node has an associated role that is equal to a role of the particular node.

15. The system of claim 13, wherein the parent node has an associated specialty that is broader than a specialty of the particular node.

16. The system of claim 10, wherein the content delivery system performs further operations comprising:
wherein associating the entity with the content delivery campaign comprises associating the entity and a value of the matched child node to the content delivery campaign;
identifying sets of entities associated with the content delivery campaign, wherein each set of the sets of entities represent a match based upon a value corresponding to a specific job title; and
determining performance metrics of each of the sets of entities associated with the content delivery campaign, wherein the performance metrics are based upon click-through rate of entities.

17. The system of claim 16, wherein the content delivery system performs further operations comprising:
associating the performance metrics of each of the sets of entities to a click-through performance attribute value of the corresponding one or more child nodes; and wherein the click-through performance attribute value of the corresponding one or more child nodes is used to identify child nodes for future associations to the particular profile attribute of the entity for future content delivery campaigns.

18. The system of claim 10, wherein the particular profile attribute is job title or skills.

19. A computer program product comprising:
one or more non-transitory computer-readable storage media comprising instructions which, when executed by one or more processors, cause:
determining a first value of a particular profile attribute of the entity;
identifying, in a value tree of a plurality of nodes, a particular node that matches the first value;
identifying, in the value tree, a parent node of the particular node;
identifying, in the value tree, one or more child nodes of the parent node, wherein the one or more child nodes do not include the particular node;
associating values of the one or more child nodes with the particular profile attribute of the entity;
receiving a particular value for a particular targeting criterion of the content delivery campaign;
determining whether the particular value matches a value of one of the one or more child nodes, wherein the particular value does not match the first value; and
in response to determining that the particular value matches a value of one of the one or more child nodes, associating the entity with the content delivery campaign.

20. The computer program product of claim 19, wherein identifying the one or more child nodes comprises:
identifying a plurality of child nodes of the parent node, wherein the plurality of child nodes does not include the particular node; and
identifying the one or more child nodes of the plurality of child nodes having an attribute value greater than or equal to a particular attribute threshold that defines desirable attribute values for association with the particular profile attribute of the entity, wherein the one or more child nodes are at least a subset of the plurality of child nodes.
